(19) United States
(12) Patent Application Publication
(10) Pub. No.: US 2006/0026902 A1
(43) Pub. Date: Feb. 9, 2006

(54) Lifting mechanism for access hatch

(76) Inventors: Timothy J. McKernen, Baldwinsville, NY (US); Mark D. Pulver, Chittenago, NY (US)

Correspondence Address: BOND, SCHOENECK & KING, PLLC, ONE LINCOLN CENTER, SYRACUSE, NY, 13202-1355, US

(21) Appl. No.: 10/910,994

(22) Filed: Aug. 4, 2004

(51) Int. Cl. E05F 15/02

(52) U.S. Cl. 49/340

(57) ABSTRACT

A mechanism for providing assistance in opening the cover of an access hatch having a frame wherein the cover is pivotally mounted to the frame. The mechanism includes a spring mounted in a housing having a large diameter tube and a small diameter tube, with the smaller tube being attached to the cover. The tubes interact in a telescoping fashion. The mechanism is mounted to the frame by a slotted hanging bracket.

### BACKGROUND OF THE INVENTION

1. Field of the Invention

The present invention relates generally to hatches for controlling access to installations such as sewers, manholes, cellars, confined spaces and the like. The present invention relates more specifically to an improved lifting mechanism to assist in the operation of an access hatch.

2. Description of Prior Art

Access hatches and lifting mechanisms for access hatches have been in use in one form or another for a long period of time. A representative of such devices are disclosed in the following U.S. patents: U.S. Pat. No. 6,640,495 to McKernan; U.S. Pat. No. 6,021,606 to Kos; and, U.S. Pat. No. 5,373,665 to Lyons.

An access hatch, sometimes referred to as horizontal doors, are typically used in o sidewalks, in the floors of industrial facilities for access to subterranean locations and for roof access in large buildings. The hatch or door structure is usually mounted horizontally. The access hatch is usually constructed of metal and because of the weight of the door the access hatches normally include some type of lift assist mechanism.

Access doors are usually manufactured with a frame that includes a channel surrounding the door with the frame being secured to the door opening. The access hatch is hinged to the frame so that it swings upwardly to the open vertical position or downwardly to the closed horizontal position. The access hatch usually includes a lift assist mechanism which comprises two concentric cylinders mounted between the frame and the door and containing a spring therein. The spring cylinders comprise two cylinder halves sealed at the ends which slide together about an internal spring. As the doors close, the spring inside the spring cylinders is compressed thereby providing a counterbalancing force. Similarly, when a door is opened the spring provides a force swinging the door upward to the open position. The bottom half of the spring cylinder is typically pivotally connected to the frame at the concentric upper half of the spring cylinder is typically connected at its upper end to a flange on the underside of the door. Accordingly, when the doors move to an open or close position, the spring cylinders pivot about their upper and lower access either compressing or decompressing the spring.

Installation of the access hatch can be accomplished using a precast concrete structure. The frame of the access hatch is mounted in the structure. Precast concrete companies typically pour concrete slabs that are 6 to 8 inches in thickness/height. Prior art lift assist mechanisms are typically 12 inches in height to accommodate the necessary spring cylinder and mounting hardware which is located at the end of the spring cylinders. There is a need to provide an access hatch with a lift assist mechanism that has a height in the 6 to 8 inch range thereby making the job of preparing a precast concrete structure that much easier and economical.

Due to the weight of the doors, the springs used to counterbalance the doors are very strong and produce large forces in the spring housing when the door is in both the open door and closed door positions. Forces generated by the spring act on each half of the spring housing with forces being generally concentrated at the pivot points at the frame flange and at the door flange. Given the large forces at work in the springs and concentric cylinders, there is often a need to replace the lift assist mechanism. Heretofore, it has been a difficult and time consuming job to replace the spring cylinders due to the nature of the mounting of the cylinders to the structure. There is a need to provide a lift assist mechanism that is easily replaceable and/or repairable.

Another problem with prior art spring cylinders is that the cylinders are sealed at the lower ends and inevitably some debris is generated through use of the door, and the debris finds its way into the spring cylinder mechanism. The build-up of debris within the cylinder eventually leads to a necessity to clean the spring cylinder or in some cases actual failure of the mechanism. It would be advantageous to provide a lift assist mechanism that is not prone to failure due to build-up of debris within the spring mechanism.

3. Objects and Advantages

It is therefore an object of the present invention to provide an access hatch that avoids the limits and problems associated with the prior art.

It is another object of the present invention to provide a lift assist mechanism that avoids the limits and problems associated with the prior art.

It is yet another object of the present invention to provide a lift assist mechanism that resists damage associated with the buildup of debris in the mechanism.

It is still yet another object of the present invention to provide a life assist mechanism that is easily repaired or replaced.

### SUMMARY OF THE INVENTION

In accordance with the foregoing objects and advantages, the present invention provides a mechanism for providing assistance in opening the cover of an access hatch having a frame wherein the cover is pivotally mounted to the frame. The mechanism includes a spring mounted in a housing having a large diameter tube and a small diameter tube, with the smaller tube being attached to the cover. The tubes interact in a telescoping fashion. The mechanism is mounted to the frame by a slotted hanging bracket.

### BRIEF DESCRIPTION OF THE DRAWINGS

The present invention will be more fully understood and appreciated by reading the following Detailed Description in conjunction with the accompanying drawings, in which:

FIG. 1 is a perspective view of a prior art access hatch;

FIG. 2 is a side plan view of a lift assist mechanism constructed in accordance with the present invention;

FIG. 3a is a side plan view of a mounting bracket constructed in accordance with present invention;

FIG. 3b is a top plan view of a mounting bracket constructed in accordance with the present invention;

FIG. 4a is a side plan view of one component of the lift assist mechanism constructed in accordance with the present invention; and,

FIG. 4b is a side plan view of one component of the lift assist mechanism constructed in accordance with the present invention.

### DETAILED DESCRIPTION

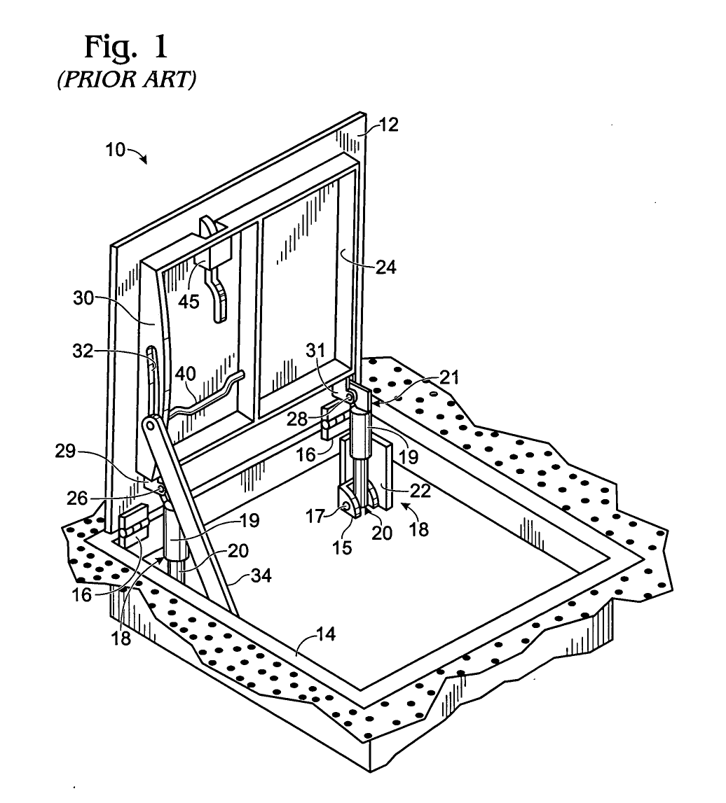

Referring now to the drawings, wherein like reference numerals refer to like parts throughout, there is seen in FIG. 1 a prior art lift assisted horizontal door assembly, sometimes referred to as an access hatch, is generally indicated as 10. The assembly includes a cover 12 hinged to a frame 14 with hinges 16. The frame 14 is typically a channel frame but is shown here as a solid member for convenience.

A lift assist mechanism comprising a spring cylinder shown generally as 18 is pivotally mounted between the frame 14 and the cover 12. Spring cylinders are well known in the art and comprise two cylindrical halves shown as a top cylinder 19 and bottom cylinder 20 and which are sealed at the ends and would slide together about an internal spring (not shown). As the cover 12 is closed, the spring inside spring cylinder 18 is compressed thereby providing the counter balance support. When the door is opened the spring in spring cylinder 18 is decompressed and would lift the cover 12.

The lower end of bottom cylinder 20 of spring cylinder 18 is pivotally connected to a yoke bracket 15 by pivot pin 17 with the bracket 15 being attached to structural member 22 which member 22 is attached to the frame 14. The top cylinder 19 of the spring cylinder 18 is pivotally connected to the cover 12 by yokes 31 and 29 and is connected to the door below the door stiffener 24 and control slot member 30, respectively. The top cylinder 19 of the left spring cylinder 18 in FIG. 1 is pivotally connected to yoke 29 via a pivot pin 26 which enables rotation of the spring cylinder 18 as the door is closed and opened. The top cylinder 19 of the right spring cylinder 18 is mounted in a similar manner via pivot pin 28 yoke 31.

Control slot member 30 acts like door stiffener 24 except that it also includes a curved controlled slot 32 for opening and closing the door. A control arm 34 is pivotally mounted to the frame 14 at a front end near the bottom of the arm 34. The second end of the top of the arm 34 swings in slot 32. A handle 40 is provided to assist in opening and closing the door. A latch mechanism 45 is shown connected to the door and will mate with a locking mechanism at the opposed end of frame 14 (not shown) when the cover 12 is closed.

In general, to provide a hold open force, the door is designed such that the internal spring of spring cylinders 18 are slightly compressed when the door is fully open. This is accomplished by selecting appropriate lengths of the spring inside the spring cylinder.

The cover 12 may be of any desired size. Extra structural members and stiffeners are added as necessary for the intended application, which may include foot traffic or vehicle traffic on the upper surface of the door. The door and frame are commonly manufactured of steel or heavy gauge aluminum and sufficient extra counter balancing spring cylinders are added in parallel between the door and the frame to counter balance the weight of the door.

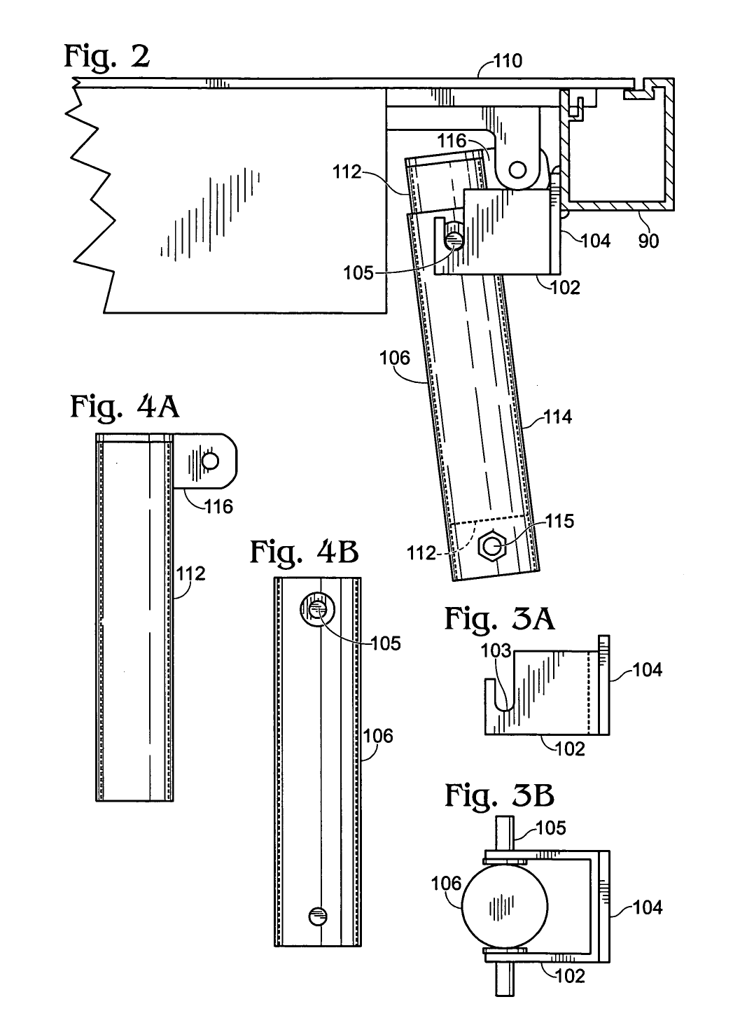

Referring now to FIGS. 2, 3a and 3b, there is shown the lift assist mechanism 100 of the present invention. The entire access hatch (not shown) is constructed and operates essentially as described in FIG. 1, however, the lift assist mechanism 100 differs from the prior art and is the focus of this discussion. The mechanism 100 includes a hanger bracket 102 with a mounting plate 104 that is mounted to the frame 90 of the access hatch approximately 6 inches below the door 110 of the access hatch. The placement of the hanger bracket 102 allows for the casting of the door support (not shown) to be poured to a level smaller than is typically used in the prior art, which offers advantages in terms of materials and manpower associated with the initial installation of the access hatch. The hanger bracket 102 includes a slotted opening 103 that is configured to accept a mounting pin 105 of the spring mechanism 106.

Referring to FIGS. 2, 4a and 4b, the spring mechanism 106 consists of two cylindrical tubes, a top tube 112 and a bottom tube 114. The top tube 112 has a slightly smaller diameter than the bottom tube 114 to allow for the telescoping configuration of the tubes as shown. In the preferred embodiment, the top tube 112 has a diameter of approximately 2 inches while the bottom tube 114 has a diameter of approximately 2¼ inches. The spring mechanism 106 includes a compression spring (not shown) in the interior of the tubes, as is known in the prior art. The compression spring is mounted by a pin 115 located at the lower end of the bottom tube 114. The configuration of the tubes in the present invention is unique in that the tubes are hollow, with the bottom tube 114 having a larger diameter than the top tube 112. This unique feature allows for any debris that finds its way into the mechanism to pass through the mechanism. In this fashion, debris does not accumulate within the tube, thereby extending the life of the spring mechanism.

The top tube 112 includes a flange 116 that is used to connect the lifting mechanism 100 to the door 110. The bottom tube 114 includes a mounting pin 105 that is positioned along the length of the tube 114 which allows the lifting mechanism 100 to interact with and be supported by the hanger bracket 102. This is in contrast to the prior art where the bottom tube is mounted at the bottom of its length to the frame at a depth of typically 10-12 inches. In this fashion, if the lifting mechanism 100 of the present invention requires repair or replacement, the technician merely needs to disconnect the flange 116 from the door 110 and then simply remove the cylindrical spring from the mounting bracket 102 by disengaging the pin 105 from the slotted bracket 103.

The component parts of the lift assist mechanism are constructed of materials that are well known in the art, including but not limited to stainless steel.

While the preferred embodiments of the invention have been particularly described in the specification and illustrated in the drawings, it should be understood that the invention is not so limited. Many modifications, equivalents and adaptations of the invention will become apparent to those skilled in the art without departing from the spirit and scope of the invention, as defined in the following claims.

What is claimed is:

1. An access hatch, comprising:
a frame containing an access opening therethrough;
a cover pivotally mounted to said frame; and,
a mechanically assisted lifting mechanism, said mechanism mounted to the access hatch by a slotted hanging bracket.

2. The access hatch of claim 1 further comprising:
a spring mounted in a housing, said housing including a large diameter tube and a small diameter tube, said small diameter tube attached to said cover, wherein the tubes interact in a telescoping fashion.

3. A mechanism for providing assistance in opening the cover of an access hatch having a frame and the cover being pivotally mounted to the frame, said mechanism comprising:
a spring mounted in a housing, said mechanism mounted to said frame by a slotted hanging bracket.

4. The mechanism of claim 3 wherein said housing comprises a large diameter tube and a small diameter tube, said small diameter tube attached to the cover, wherein the tubes interact in a telescoping fashion.
